(19) United States
(12) Patent Application Publication
(10) Pub. No.: US 2009/0238952 A1
(43) Pub. Date: Sep. 24, 2009

(54) METHOD OF MANUFACTURING SLIDER

(75) Inventors: Mitsuru KUBO, Kawasaki (JP); Masayuki HAMAKAWA, Kawasaki (JP); Satoshi TOMITA, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/404,362

(22) Filed: Mar. 16, 2009

(30) Foreign Application Priority Data
Mar. 21, 2008 (JP) 2008-074435

(51) Int. Cl. B05D 5/12

(52) U.S. Cl. 427/58

(57) ABSTRACT

The method of manufacturing a head slider is capable of improving a floating characteristic and an electromagnetic conversion characteristic of the head slider. The method comprises the steps of: forming terminals on a leading end face of a row bar; forming a resist pattern, which corresponds to a configuration of an air bearing surface section to be formed on a facing surface of the row bar; partially thinning the facing surface of the row bar until reaching a groove surface so as to form the air bearing surface section; forming a base layer of a step section on the groove surface; forming a heater circuit, which is electrically connected to the terminals, on the base layer; and coating the base layer, on which the heater circuit has been formed, with a thermal expansion material layer so as to form the step section.

### BACKGROUND OF THE INVENTION

The present invention relates to a method of manufacturing a head slider, more precisely relates to a method of manufacturing a head slider, in which a row bar cut from a wafer substrate is uniquely processed.

In a head slider of a magnetic storage unit, step-shaped sections, i.e., an air bearing surface (ABS) section(s) and a step section(s), are formed in a facing surface, which faces a surface of a recording medium, thereby the head slider can be floated from the surface of the recording medium by an air stream, which is generated by rotation of the recording medium. Step-shaped sections of head sliders have different configurations. In some head sliders, step-shaped sections have different heights.

An example of a head slider having step-shaped sections, whose heights are different, is shown in FIG. 23. The head slider 10 is formed on a substrate 11 composed of ALTIC (Al₂O₃—TiC), and ABS sections 14a and 14b and step sections 15a and 15b are formed in a facing surface of the substrate 11, which will face a recording medium. The step sections 15a and 15b are one-step lower than the ABS sections 14a and 14b. Further, a groove surface 16 , which is outwardly extended from the ABS sections 14a and 14b and the step sections 15a and 15b, is one-step lower than the step sections 15a and 15b. Note that, in the present specification, surfaces of the ABS sections 14a and 14b, which will face the recording medium, are called air bearing surfaces (ABSs); surfaces of the step sections 15a and 15b, which will face the recording medium, are called step surfaces.

A sensor 12, which includes a read-element and a write-element, is formed on a side face of the substrate 11, which is perpendicular to the facing surface of the head slider 10. The sensor 12 is constituted by thin films so as to form the read-element, etc. on a wafer substrate.

The ABS sections 14a and 14b, the step sections 15a and 15b, and the groove surface 16 are formed by the steps of: laminating films on the wafer substrate; cutting a row bar from the wafer substrate; abrading a surface of the row bar, which will face the recording medium; and ion-milling the abraded surface of the row bar so as to form the step-shaped sections.

The conventional method is disclosed in, for example, Japanese Laid-open Patent Publications No. 2005-276284 and No. 2002-373477.

However, the conventional method of manufacturing a head slider has following problems. Namely, when the step-shaped sections are formed in the facing surface of the head slider, the head slider is ion-milled, so burrs will stick onto the facing surface and will damage the recording medium.

The production process of the head slider includes steps of abrading and cutting the ALTIC substrate, so particles of the ALTIC material, which fall from a tip or a crack formed while processing the wafer substrate, invade into a clearance between the head slider and the recording medium. Therefore, disk crush will be caused during the operation.

Heights of the ABS sections and the step sections are fixed, but a relative rotational speed of the recording medium with respect to the head slider is varied depending on positions of the head slider with respect to the recording medium, e.g., a position facing a center part of the recording medium, a position facing an outer part of the recording medium. Therefore, an amount of floating the head slider from the recording medium varies.

To restrain the variation of the amount of floating the head slider, a dynamic flighing height (DFH) method, in which a heater circuit is formed in the sensor and a clearance between the sensor and the recording medium is adjusted by thermal expansion of a thermal expansion material of the sensor which is controlled by passing an electric current through the heater circuit, is proposed. However, the heater circuit is located close to the sensor, so the heat will badly influence characteristics of the sensor.

The heater circuit may be formed in the ABS of the head slider, but the head slider or the sensor is located close to the recording medium and the disk crush will be occurred.

### SUMMARY OF THE INVENTION

The present invention was conceived to solve the above described problems.

An object of the present invention is to provide a method of manufacturing a head slider, which is capable of improving a floating characteristic and an electromagnetic conversion characteristic of the head slider and preventing a recording medium from being damaged by burrs, etc. stuck on a surface of the head slider.

To achieve the object, the present invention has following constitutions.

Namely, the method of manufacturing a head slider comprises the steps of: forming terminals on a leading end face of a row bar, to which an air inflows; forming a resist pattern, which corresponds to a configuration of an air bearing surface (ABS) section to be formed on a facing surface of the row bar, which will face a storage medium; partially thinning the facing surface of the row bar until reaching a groove surface, with using the resist pattern as a mask, so as to form the ABS section; forming a base layer of a step section on the groove surface; forming a heater circuit, which is electrically connected to the terminals, on the base layer; and coating the base layer, on which the heater circuit has been formed, with a thermal expansion material layer so as to form the step section.

In the method, the base layer of the step section may be formed on the groove surface after forming the ABS section, the heater circuit may be formed on the base layer, and the base layer, on which the heater circuit has been formed, may be coated with the thermal expansion material layer. With this method, the heater circuit can be formed in the ABS section.

The method may further comprise the step of finish-abrading an ABS of the ABS section, which is performed after forming the ABS section and the step section. With this method, the ABS can be accurately formed.

The method may further comprise the steps of: cutting the row bar, which is supported by a supporting jig, to form the head slider after forming the ABS section and the step section; and finish-abrading an ABS of the head slider, which is supported by the supporting jig.

The method may further comprise the steps of: cutting the row bar, which is supported by a supporting jig, to form the head slider after forming the ABS section and the step section; and coating an outer surface of the head slider, which is supported by the supporting jig, with a protection film. With this method, the head slider including the outer surface can be coated with the protection film.

By employing the method of the present invention, the heater circuit is formed in the step section, so that a height of the step surface can be adjusted by controlling thermal expansion of the step section. Height variation of the step surface, which is caused in the steps of processing the head slider, can be absorbed, so that characteristics of the head slider can be improved.

### BRIEF DESCRIPTION OF THE DRAWINGS

Embodiments of the present invention will now be described by way of examples and with reference to the accompanying drawings, in which:

FIG. 1 is a perspective view of an ALTIC substrate, on which head sliders will be formed;

FIG. 2 is a perspective view of the ALTIC substrate, on which element sections are formed;

FIG. 3 is a perspective view of stack bars, which are separated from the ALTIC substrate;

FIG. 4 is an explanation view showing a manner of processing a row bar;

FIG. 5 is a plan view of a setting plate, on which row bars are set;

FIG. 6 is a plan view of the processed row bars;

FIG. 7 is an explanation view showing a manner of cutting the row bar into head sliders;

FIG. 8 is a partial perspective view showing a structure of the row bar;

FIG. 9 is a partial perspective view of the row bar, in which terminals are formed;

FIG. 10 is a partial perspective view of the row bar, in which an LE surface is coated with an insulating material;

FIG. 11 is a partial perspective view of the row bar, in which resist patterns for forming ABS sections are formed in an abraded surface;

FIG. 12 is a partial perspective view of the row bar, in which the ABS sections and a groove surface are formed;

FIG. 13 is a partial perspective view of the row bar, in which base layers of step sections are formed;

FIG. 14 is a partial perspective view of the row bar, in which heater circuits are respectively formed in the base layers;

FIG. 15 is a partial perspective view of the row bar, in which the heater circuits are respectively coated with thermal expansion material layers;

FIG. 16 is a partial perspective view of the row bar, in which a concave part for forming a heater circuit is formed in the ABS section;

FIG. 17 is a partial perspective view of the row bar, in which the heater circuit is formed in the ABS section;

FIG. 18 is a perspective view showing a manner of cutting the row bar into head sliders

FIG. 19 is an explanation view showing a manner of finish-abrading the ABSs of the row bar;

FIG. 20 is a perspective view of the abraded head slider;

FIG. 21 is a perspective view of the head slider coated with a protection film;

FIG. 22 is a sectional view taken along a line A-A shown in FIG. 21, wherein an arrangement of the ABS, the step surfaces and the groove surface is shown; and

FIG. 23 is a perspective view of the conventional head slider having the ABS sections and the step sections.

### DETAILED DESCRIPTION OF THE EMBODIMENTS

Preferred embodiments of the present invention will now be described in detail with reference to the accompanying drawings.

(Basic Steps of Manufacturing Head Slider)

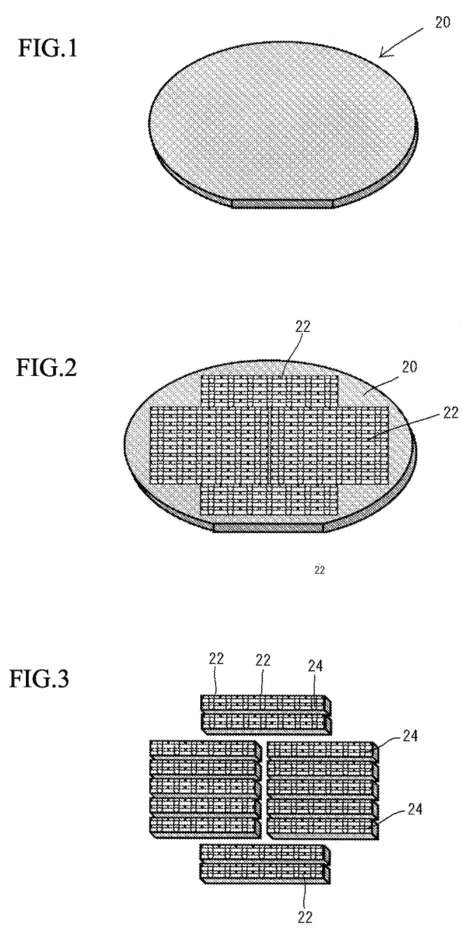

Basic steps of manufacturing a head slider will be explained with reference to FIGS. 1-7. A wafer substrate 20, which is composed of ALTIC (Al₂O₃—TiC) and on which head sliders will be formed, is shown in FIG. 1. In FIG. 2, element sections 22, which are formed by laminating films and each of which has a sensor including a read-element and a write-element, are formed on the ALTIC substrate 20. A number of the element sections 22 are metrically formed on the ALTIC substrate 20.

In FIG. 3, the ALTIC substrate 20, on which the element sections 22 have been formed, is cut along arrays of the element sections 22 so as to form a plurality of blocks 24. Each of the blocks 24 is called a stack bar, in each of which row bars are piled. In each of the row bars, a plurality of the element sections 22 are serially arranged in the longitudinal direction.

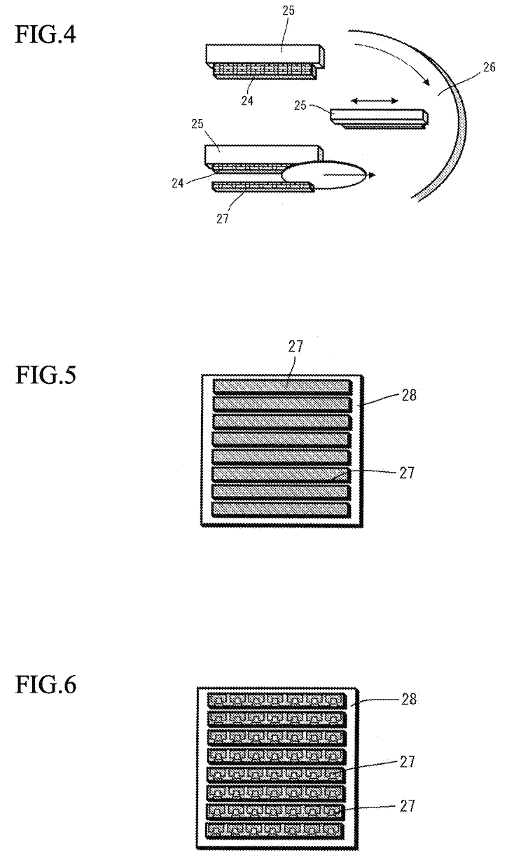

In FIG. 4, the stack bar 24 is cut to form row bars 27. In the shown step, the stack bar 24 is adhered to a supporting jig 25, which is composed of an electrically conductive ceramic, and then air bearing surfaces (ABSs) of the stack bar 24 in which the sensors are exposed, are abraded, by an abrasive plate 26, until sizes of the sensors reach a prescribed size.

Generally, the ABSs and the sensors are finish-abraded, in the abrading step, to have the prescribed size. On the other hand, in the method of the present invention, the ABSs are finish-abraded and the sensors are finally positioned in the following step. Therefore, an abrasive margin, which will be removed in the finish-abrading step, is left in this abrading step.

After completing the abrading step, the outermost row bar 27 of the stack bar 24 is cut from the stack bar 24 and set on a setting plate 28 composed of an electrically conductive ceramic (see FIG. 5).

A cut surface of the stack bar 24 is abraded every time the row bar 27 is cut from the stack bar 24, and then the new outermost row bar 27 is cut from the stack bar 24. This process is repeated, and the row bars 27 cut from the stack bar 24 are set on the setting plate 28 in order (see FIG. 5). The row bars 27 are set on the setting plate 28 with their abraded surfaces being in an upward direction.

Next, ABS sections and step sections of the row bars 27 are formed in the sate in which the row bars 27 are set on the setting plate 28. The ABS sections and the step sections formed in the abraded surfaces of the row bars 27 are shown in FIG. 6.

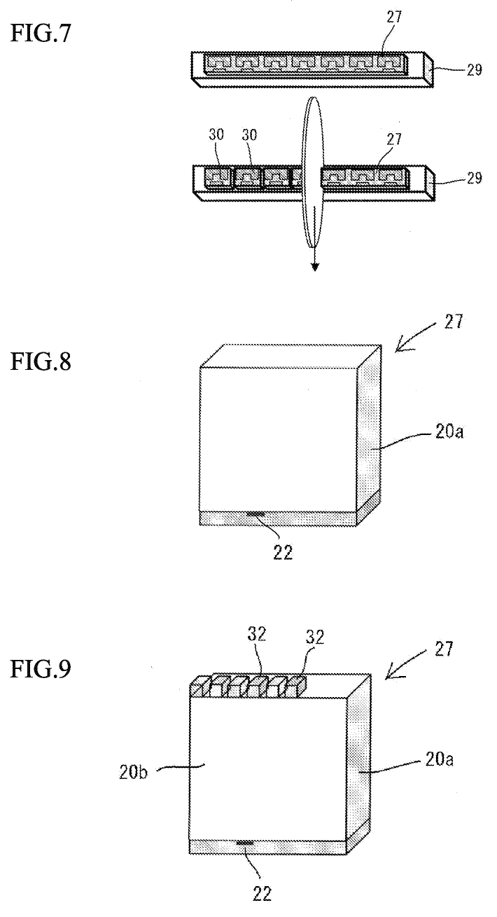

In FIG. 7, the row bar 27, in which the ABS sections and the step sections have been formed, is adhered onto a ceramic tool 29, and the row bar 27 is cut into separated head sliders 30. With this step, the separated head sliders 30, in each of which the ABS sections and the step sections are formed in the abraded surface, can be produced.

(Characteristic Steps of Manufacturing Head Slider)

The above described production steps shown in FIGS. 1-7 are the basic steps of manufacturing the head slider. On the other hand, the characteristic steps of the present embodiment are modified steps of the steps shown in FIGS. 5-7. Namely, the step of forming the ABS sections and the step sections to the step of cutting the row bar 27 to form the separated head sliders 30 are modified.

FIGS. 8-21 show the steps of processing the row bar cut from the ALTIC substrate. Note that, FIGS. 8-17, 20 and 21 are perspective views of one of the head sliders formed in the row bar.

FIG. 8 shows the abraded row bar 27. The row bar 27 is constituted by a base member 20a composed of ALTIC and the element section 22, which is formed on a surface (lower surface) of the base member 20a. The element section 22 are serially formed in the longitudinal direction of the row bar 27 at regular intervals and respectively corresponded to the head sliders formed in the row bar 27.

In FIG. 9, terminals 32 of heater circuits are formed on a leading end face (LE surface) of the row bar 27, to which an air will inflow. The terminals 32 are formed by the steps of: applying resist on the LE surface of the row bar 27; optically exposing and developing the resist so as to form concave parts, in each of which the LE surface is exposed as an inner bottom surface and the terminal 32 will be formed, and filling the concave parts with an electrically conductive metal, e.g., copper, by sputtering.

Ends of the heater circuits will be connected to end faces of the terminals 32, which are parallel to an abraded surface (a facing surface) 20b of the row bar 27, in the step of forming the heater circuits. Therefore, the terminals 32 are formed at suitable positions, at which the ends of the heater circuits can be easily connected to the terminals 32 in the step of forming the heater circuits.

Note that, the terminals 32 may be formed in the LE surface of the row bar 27 by performing the sputtering from the abraded surface side of the row bar 27. To easily form the terminals 32, the resist pattern is formed on the LE surface of the row bar 27 and the sputtering is performed from the LE surface side.

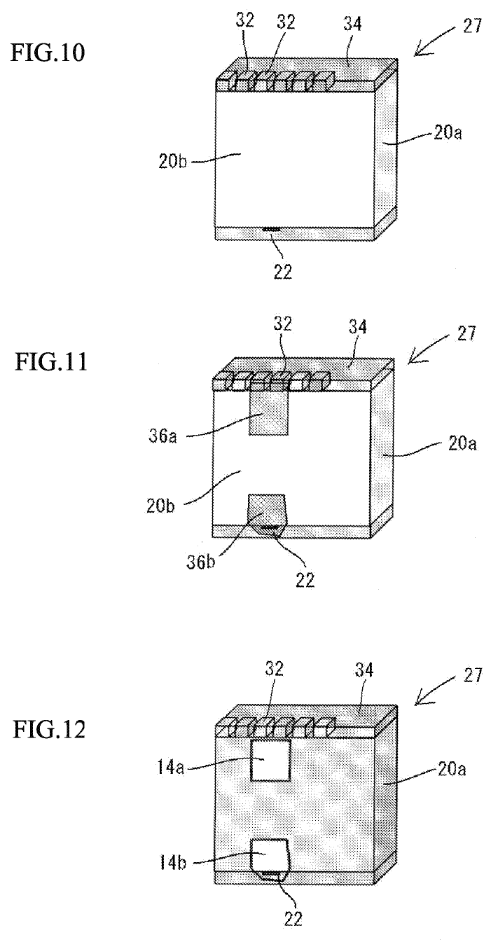

In FIG. 10, the LE surface of the row bar 27, on which the terminals 32 have been formed, is coated with an insulating material 34, e.g., alumina. End faces (upper end faces) of the terminals 32, which are parallel to the LE surface, are exposed in an upper surface of the insulating material 34. For example, the LE surface of the row bar 27 may be coated with the insulating material 34 by a photolithographic method. Namely, the upper end faces of the terminals 32, which are parallel to the LE surface, are coated with resist, the insulating material 34 is applied to the LE surface by sputtering, and then the resist is removed, thereby the upper end faces of the terminals 32 can be exposed in the upper surface of the insulating material 34 coating the LE surface of the row bar 27.

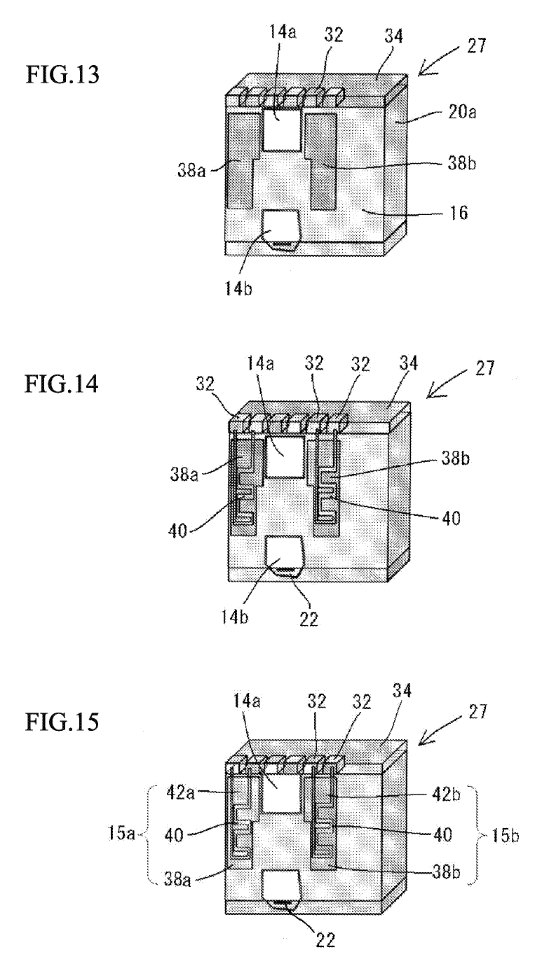

FIGS. 11 and 12 show the steps of forming the ABS sections 14a and 14b in the abraded surface 20b of the row bar 27.

In FIG. 11, resist patterns 36a and 36b, whose planar configurations are the same as those of the ABS sections 14a and 14b to be formed, are formed on the abraded surface 20b of the row bar 27. The resist patterns 36a and 36b, whose configurations are the same as those of the ABS sections 14a and 14b, are formed by coating the abraded surface 20b of the row bar 27 with the resist and optically exposing and developing the resist.

In FIG. 12, the abraded surface 20b of the row bar 27 is ion-milled so as to form the ABS sections 14a and 14b and a groove surface 16. Since the base member 20a is protected by the resist patterns 36a and 36b, the ABS sections 14a and 14b are level with the abraded surface 20b. On the other hand, the groove surface 16 is made thinner by ion milling, thereby the groove surface 16 is one-step lower than the ABS sections 14a and 14b.

The conventional method of manufacturing the head slider, which has the ABS sections and the step sections, comprises the steps of: ion-milling outer regions of the ABS sections until reaching step surfaces; coating the ABS sections and the step sections with resist; and ion-milling outer regions of the step sections until reaching the groove surface. The ion milling is performed twice for forming the ABS sections, the step sections and the groove surface. On the other hand, the present embodiment is characterized in that the ion milling is performed, beyond the step surfaces, until reaching the groove surface 16 when the ABS sections 14a and 14b are formed.

Note that, when the resist patterns 36a and 36b are formed, the terminals 32 are coated with the resist pattern 36a so as to protect the terminals 32 while performing the ion milling. The resist pattern 36b is patterned so as to coat and protect the sensor of the element section 22.

In the present embodiment, the ABS sections 14a and 14b are separately formed on the element section 22 side and on the terminal 32 side. The ABS sections 14a and 14b can be optionally formed by patterning the resist.

FIGS. 13-15 show the steps of forming the step sections 15a and 15b.

In FIG. 13, base layers 38a and 38b of the step sections 15a and 15b are formed on the groove surface 16. Planar configurations of the base layers 38a and 38b are the same as those of the step sections 15a and 15b.

In the present embodiment, the heater circuits will be formed in the step sections 15a and 15b. In this case, preferably, the base layer 38a and 38b are composed of a low-thermal expansion material so as to restrain heat conduction from the heater circuits to the base member 20a. In case of forming the heater circuit, the base layers 38a and 38b are composed of an electrically insulating material, e.g., alumina, so as to electrically insulate from the base member 20a.

Note that, in case of forming no heater circuits in the step sections 15a and 15b, the base layers 38a and 38b may be composed of a good heat conductive material, e.g., metal, or an electrically conductive material. In this case, the base layers 38a and 38b themselves act as the step sections 15a and 15b.

The base layers 38a and 38b are formed by the steps of: coating the surface of the row bar 27 including the groove surface 16 with resist; patterning the resist to form opening sections corresponding to the base layers 38a and 38b; and filling the opening sections with the material of the base layers 38a and 38b, e.g., alumina, by sputtering. In FIG. 13, the resist pattern is removed after forming the base layers 38a and 38b.

In the present embodiment, the heater circuits 40 are formed in the step sections 15a and 15b, so the heater circuits 40 are patterned on the surfaces of the base layers 38a and 38b after forming the base layers 38a and 38b. The heater circuits 40 are formed by the steps of: coating the base layers 38a and 38b with resist; patterning the resist according to configurations of the heater circuits 40; and filling the resist patterns with an electrically conductive material, e.g., Ti, Ta, by sputtering. By forming the thin and winding heater circuits 40 on the surfaces of the base layers 38a and 38b with a suitable electrically conductive material, desired heater circuits can be formed. In FIG. 14, the heater circuits 40 are formed on the surfaces of the base layers 38a and 38b.

The ends of the heater circuits 40 are electrically connected to the terminals 32. When the resist patterns for forming the heater circuits 40 are formed, the resist patterns are designed to extend the ends of the heater circuits 40 until reaching the end faces of the terminals 32. Since the end faces of the terminals 32, which will face a recording medium, are exposed, the heater circuits 40 can be electrically connected to the terminals 32 by sputtering the electrically conductive material after forming the resist patterns.

In the present embodiment, the ABS sections 14a and 14b are formed between the step sections 15a and 15b. Therefore, the base layers 38a and 38b are formed on the both sides of the ABS sections 14a and 14b. The heater circuits 40 are respectively formed on the base layers 38a and 38b, and the heater circuits 40 are respectively connected to the terminals 32. Each of the heater circuits 40 is connected to the plus terminal 32 and the minus terminal 32, so the heater circuits 40 are connected to four of the terminals 32.

After forming the heater circuits 40, the base layers 38a and 38b are coated with thermal expansion material layers 42a and 42b, and the heater circuits 40 are encased therein as shown in FIG. 15. The thermal expansion material layers 42a and 42b too may be formed by forming resist patterns according to the planar configurations of the base layers 38a and 38b and sputtering a thermal expansion material. The thermal expansion material is easily expanded by the heat generated by the heater circuits 40.

For example, the thermal expansion material of the thermal expansion material layers 42a and 42b is TiW. In case that the thermal expansion material layers 42a and 42b are composed of an electrically conductive material, insulating layers are provided to the thermal expansion material layers 42a and 42b.

The surfaces of the thermal expansion material layers 42a and 42b become the step surfaces, i.e., an outer surface of the head slider, so the thermal expansion material must be selected in consideration of corrosion resistance and lubricity to the recording medium. Outermost layers of the thermal expansion material layers 42a and 42b may be composed of a material having enough corrosion resistance, and a plurality of metal layers, which are composed of high-thermal expansion metals, and insulating layers may be formed in the thermal expansion material layers 42a and 42b as inner layers.

Since the outer surfaces of the step sections 15a and 15b define the step surfaces, thicknesses of the base layers 38a and 38b and the thermal expansion material layers 42a and 42b are suitably controlled in the forming steps so as to correctly set heights of the step surfaces with respect to the groove surface 16.

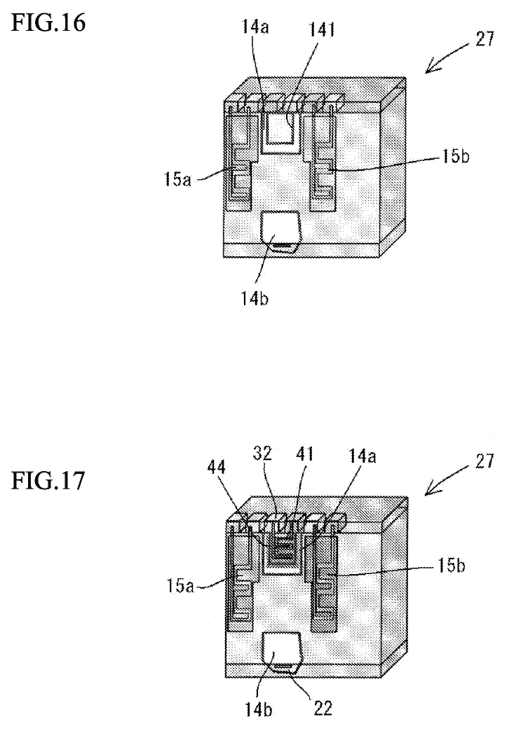

FIGS. 16 and 17 show the steps of forming a heater circuit 41 in the ABS section 14a. In the present embodiment, the heater circuit 41 is formed in the ABS section 14a located closed to the terminals 32.

In FIG. 16, a concave part 141 for accommodating the heater circuit 41 in the ABS section 14a is formed in the ABS section 14a. In the present embodiment, the ABS sections 14a and 14b will be abraded in the following step so as to finish the ABS sections 14a and 14b having a prescribed height. Therefore, the heater circuit 41 must be formed in and encased by the ABS section 14a. A depth of the concave part 141 of the ABS section 14a is greater than the sum of a thickness of a base layer 38c formed in the concave part 141, a thickness of the heater circuit 41 and a thickness of a thermal expansion material layer 44 coating the heater circuit 41. The concave part 141 may be formed by ion-milling the ABS section 14a.

In FIG. 17, the heater circuit 41 is formed in the ABS section 14a, and the heater circuit 41 is coated with the thermal expansion material layer 44. The heater circuit 41 composed of an electrically conductive material is formed into a winding pattern as well as the heater circuits 40. A process of forming the heater circuit 41 is the same as that of forming the heater circuits 40.

In the present embodiment, the ABS section 14a is formed between the step sections 15a and 15b. Therefore, six terminals 32 are formed for the heater circuits 40 and 41 of the step sections 15a and 15b and the ABS section 14a, and they are positioned close to the step sections 15a and 15b and the ABS section 14a.

In the present embodiment, the heater circuit 41 is formed in the ABS section 14a located close to the LE surface so as not to badly influence the sensor of the element section 22. If the heater circuit 41 does not badly influence the sensor of the element section 22, a heater circuit may be formed in the ABS section 14b located close to the element section 22.

In the present embodiment, the heater circuit 41 is formed in the ABS section 14a after forming the heater circuits 40 in the step sections 15a and 15b. These steps may be reverse-sequentially performed.

Further, in the present embodiment, the heater circuits are formed in the the ABS section 14a and the step sections 15a and 15b, but the heater circuits may be formed in only the ABS section(s) or the step sections.

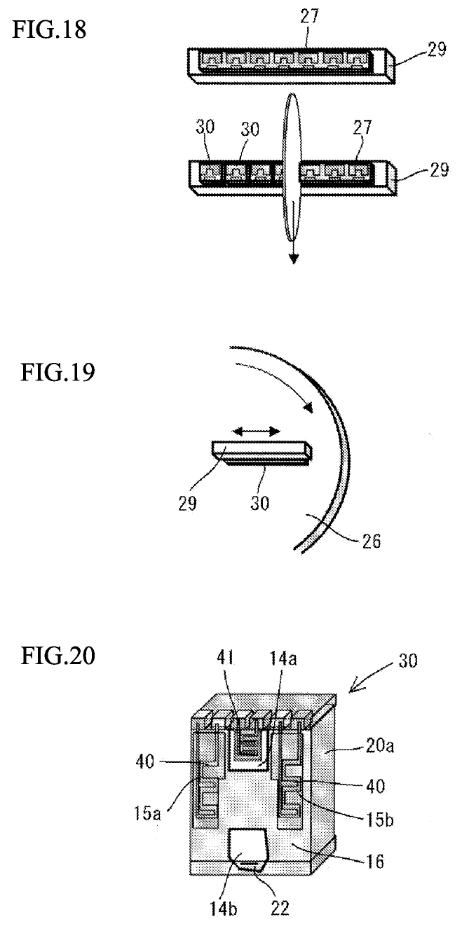

As shown in FIG. 18, the row bar 27 is adhered to a ceramic tool 29 after forming the heater circuit 41, and the row bar 27, which has been adhered to the ceramic tool 29, is cut to form separated head sliders 30.

Next, the separated head sliders 30 adhered on the ceramic tool 29 are abraded, by an abrasive plate 26, until the ABSs reach the prescribed height. Simultaneously, the sensors in the element sections 22 are finish-abraded until reaching the prescribed size. By finish-abrading the ABSs in the following step, the height of the ABSs can be accurately controlled. In case that the heater circuit 41 is formed in the ABS section 14a like the present embodiment, the ABSs can be highly flattened and the height thereof is accurately defined by the finish-abrading step.

The finish-abraded head slider 30 is shown in FIG. 20. In this process stage, the head slider 30 is still adhered on the ceramic tool 29. By cutting the row bar 27 along an intermediate line between the adjacent head sliders 30, the adjacent head sliders 30 have symmetrical configurations.

In the production steps, burrs will be formed while performing the ion milling and the cutting works, and they will stick onto the surfaces of the head sliders 30. By abrading the ABSs of the separated head sliders 30, burrs and foreign substances projected form the ABSs can be removed, so that the flat ABSs can become outermost layers of the head sliders 30. Therefore, damaging the recording medium by burrs, etc. stuck on the ABS can be prevented.

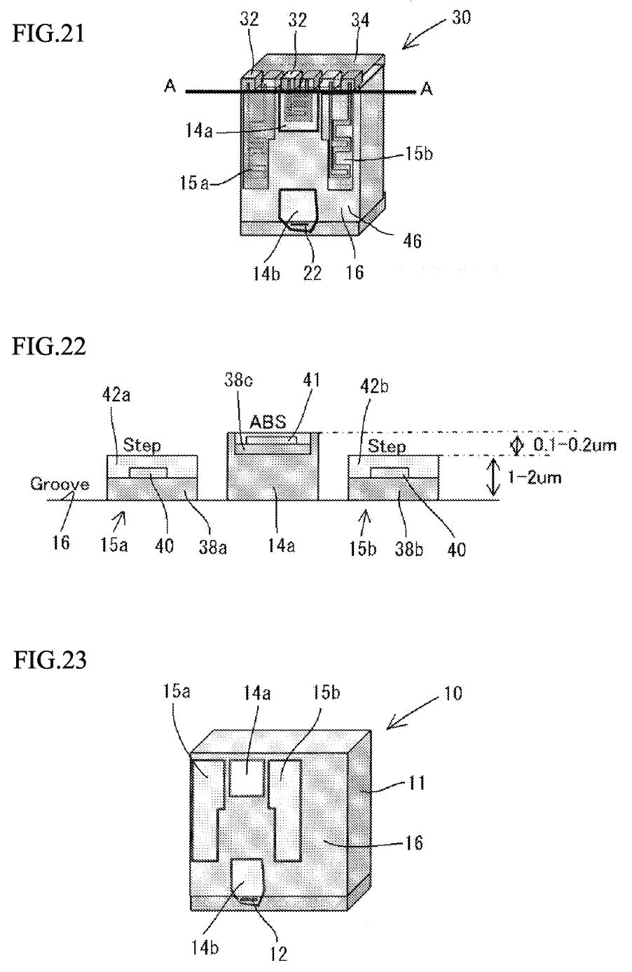

In FIG. 21, the head slider 30 is adhered on the ceramic tool 29, and outer surfaces of the head slider 30 are coated with protection films 46. The protection films 46 are composed of Si, DLC, etc. The protection films 46 are formed on the outer surfaces of the head slider 30 by sputtering a protection material. Therefore, in the head slider 30, a facing surface, which will face the recording medium, an leading end face, to which an air inflows, and both side faces are coated with the protection film 46. By entirely coating the outer surfaces of the head slider 30 with the protection films 46, a problem of falling particles of ALTIC from the head slider 30 can be solved.

After coating the outer surfaces of the head sliders 30 with the protection films 46, the head sliders 30 are peeled from the ceramic tool 29, so that the independent head sliders 30 can be obtained as products.

FIG. 22 is a sectional view taken along a line A-A shown in FIG. 21. The ABS of the ABS section 14a is the highest surface; the step surfaces of the step sections 15a and 15b are one-step lower than the ABS of the ABS section 14a; and the groove surface 16 is the lowest surface.

The step sections 15a and 15b are constituted by the base layers 38a and 38b, the heater circuits 40 and the thermal expansion material layers 42a and 42b. The ABS section 14a is constituted by the base member composed of ALTIC, the base layer 38c formed in the concave part, the heater circuit 41 and the thermal expansion material layer 44.

In the present embodiment, the height difference between the ABS and the step surfaces is about 0.1-0.2 μm, and the height difference between the groove surface 16 and the step surfaces is 1-2 μm. The height differences may be optionally designed according to products.

In case of mounting the head slider 30, which has been produced by the method of the above described embodiment, on a head suspension, the sensor of the element section 22 is electrically connected to a read/write control circuit, and the terminals of the heater circuits 40 and 41 are electrically connected to a heater control circuit. By the heater control circuit, the thermal expansion of the ABS section 14a and the step sections 15a and 15b can be controlled, so that the heights of the ABS and the step surfaces can be controlled.

In the production method of the present embodiment, the heater circuits 40 and 41 can be easily formed in the the ABS section 14a and the step sections 15a and 15b, and the heights of the ABS and the step surfaces can be controlled, so that height variation of the ABS and the step surfaces can be absorbed and the head slider having a superior electromagnetic conversion characteristic can be produced.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A method of manufacturing a head slider, comprising the steps of:
forming terminals on a leading end face of a row bar;
forming a resist pattern, which corresponds to a configuration of an air bearing surface section to be formed on a facing surface of the row bar, which will face a storage medium;
partially thinning the facing surface of the row bar until reaching a groove surface, with using the resist pattern as a mask, so as to form the air bearing surface section;
forming a base layer of a step section on the groove surface;
forming a heater circuit, which is electrically connected to the terminals, on the base layer; and
coating the base layer, on which the heater circuit has been formed, with a thermal expansion material layer so as to form the step section.

2. The method according to claim 1,
wherein the base layer of the step section is formed on the groove surface after forming the air bearing surface section,
the heater circuit is formed on the base layer, and
the base layer, on which the heater circuit has been formed, is coated with the thermal expansion material layer.

3. The method according to claim 1,
further comprising the step of finish-abrading an air bearing surface of the air bearing surface section, which is performed after forming the air bearing surface section and the step section.

4. The method according to claim 2,
further comprising the step of finish-abrading an air bearing surface of the air bearing surface section, which is performed after forming the air bearing surface section and the step section.

5. The method according to claim 1,
further comprising the steps of:
cutting the row bar, which is supported by a supporting jig, to form the head slider after forming the air bearing surface section and the step section; and
finish-abrading an air bearing surface of the head slider, which is supported by the supporting jig.

6. The method according to claim 2,
further comprising the steps of:
cutting the row bar, which is supported by a supporting jig, to form the head slider after forming the air bearing surface section and the step section; and
finish-abrading an air bearing surface of the head slider, which is supported by the supporting jig.

7. The method according to claim 1,
further comprising the steps of:
cutting the row bar, which is supported by a supporting jig, to form the head slider after forming the air bearing surface section and the step section; and
coating an outer surface of the head slider, which is supported by the supporting jig, with a protection film.

8. The method according to claim 2
further comprising the steps of:
cutting the row bar, which is supported by a supporting jig, to form the head slider after forming the air bearing surface section and the step section; and
coating an outer surface of the head slider, which is supported by the supporting jig, with a protection film.

9. The method according to claim 5
further comprising the steps of:
cutting the row bar, which is supported by a supporting jig, to form the head slider after forming the air bearing surface section and the step section; and
coating an outer surface of the head slider, which is supported by the supporting jig, with a protection film.

10. The method according to claim 6
further comprising the steps of:
cutting the row bar, which is supported by a supporting jig, to form the head slider after forming the air bearing surface section and the step section; and
coating an outer surface of the head slider, which is supported by the supporting jig, with a protection film.
